(19) United States
(12) Patent Application Publication
(10) Pub. No.: US 2016/0145893 A1
(43) Pub. Date: May 26, 2016

(54) FENCE AND GATE POST AND METHOD FOR INSTALLING A FENCE OR GATE

(71) Applicants: Chris Coulston, Sacramento, CA (US); Dale Martell, Granite Bay, CA (US)

(72) Inventors: Chris Coulston, Sacramento, CA (US); Dale Martell, Granite Bay, CA (US)

(21) Appl. No.: 14/938,743

(22) Filed: Nov. 11, 2015

Related U.S. Application Data
(60) Provisional application No. 62/078,515, filed on Nov. 12, 2014.

(51) Int. Cl. E04H 17/20; E06B 11/02; E04H 17/26

(52) U.S. Cl. CPC E04H 17/20; E04H 17/263; E04H 17/261; E06B 11/02

(57) ABSTRACT

A fence post having a front flange section, a back flange section, and a connection section interconnecting the front and back, wherein the fence post is generally a Z-shaped configuration. Each flange section has three sets of holes in a zig-zag configuration, wherein the holes have a hole-to-hole distance. A method of installing a gate using the post as a gate stop, wherein a flange section is affixed to a gate stop length of fencing, and the opposite flange makes contact with the gate and serves as a metallic gate stop.

### CROSS-REFERENCE TO RELATED APPLICATIONS

This application claims the benefit of priority under 35 U.S.C. §119(e), of U.S. Provisional Application 62/078,515, filed on Nov. 12, 2014, entitled “METAL FENCE AND GATE POST” the entirety of which is incorporated herein by reference and made a part of the present disclosure.

### FIELD OF THE INVENTION

The field of the invention relates to construction and building materials generally and fence and gate installation and support devices specifically. The field of the invention relates to a method for constructing fences, gates, and the like.

### BACKGROUND

Wood fence posts are widely employed but are prone to rot and decay. Metal fence posts in a variety of configurations are also known. Typically, metal fence posts are employed with wire fencing, however, metal posts may be used to support wood and other non-wire fencing materials.

### SUMMARY

The inventive fence post incorporates a unique hole pattern in the front and back flange sections and a connecting section thereof. This hole pattern greatly adds to the versatility of the post in that fence rails may be secured at any desired location along the length of the post above ground. Furthermore, a kickboard or retaining board can be attached horizontally along the base of the installed post above ground. Advantageously, the present inventive post provides an improved gate installation wherein a gate supported by hinges makes contact with a flange section of the inventive post which serves as a metallic gate stop thereby adding the service life of the gate and fence. Further, the inventive hole pattern has been found to ease fence installation. The post is strong, durable, not prone to rotting, twisting, warping, or bending. Additionally, the post results in a strong fence, wherein a fence constructed with the inventive post has been found to withstand winds of up to 73 miles per hour.

The post can be used as a line post, end post, corner post, and gate post. It is ideal for a wide variety of fence types, including but not limited to: good neighbor style fences, board-on-board, louvered, picket, corral, shadowbox, basketweave, and custom style fences.

The metal fence post of the present invention is shaped to define three post sections which in one embodiment are fixedly secured together. In alternative embodiments, the inventive fence post formed or shaped by bending a single elongated sheet of steel or other metal to define three sections. In other embodiments, the inventive post may be made by casting, molding, or forged in any manner known in the prior art to define three sections. The inventive post may be comprised of any solid material having sufficient strength to support adjoining construction such as fence sections, gates, and the like. These materials include both metallic and non-metallic posts.

In one embodiment, the sections are elongated and include a double-ended front flange section, a double-ended back flange section extending parallel to the front section and a double-ended center connecting section extending perpendicular to the front and back sections. The front and back flange sections have a plurality of spaced holes formed therein which may receive nails, screws, or other fasteners. In one embodiment of the present invention, the holes are in a zig-zag pattern extending the length of the front and rear sections between one end thereof to the other end thereof.

The zig-zag pattern of holes includes a plurality of aligned holes closely adjacent to the outer edges of the front and back flange sections, a plurality of aligned spaced holes extending along the lengths of the front and back flange sections closely adjacent to the connecting section and a plurality of aligned spaced holes extending the lengths of the front and back flange sections at or closely adjacent to the centers of the front and back section.

A plurality of spaced holes are located at the top and bottom end portions of the double-ended center connecting section, the holes at the top and bottom end portions extending along the longitudinal axis of the center connecting section. In an alternative, a plurality of spaced holes on the center connecting section extend continuously along the length of that section.

Other features, advantages, and objects of the present invention will become apparent with reference to the following description and accompanying drawings.

### DRAWINGS

FIG. 1 is a perspective view of an embodiment of the inventive fence post.

FIG. 2 is a front elevation view of the fence post.

FIG. 3 is a side elevation view of the fence post.

FIG. 4 is an enlarged top view of the fence post.

FIG. 5 is an enlarged detail perspective view of the upper end of the fence post as shown in FIG. 1.

FIG. 6 is an enlarged front elevation view of the upper end of the fence post as shown in FIG. 2.

FIG. 7 is an enlarged side view of the lower end of the fence post.

FIG. 8 is a perspective view illustrating a method of using the inventive post as a line post.

FIG. 9 is a perspective view illustrating a method of using the inventive post as a corner post.

FIG. 10 is a perspective view of illustrating a method of using the inventive post as a gate stop.

FIG. 11 is a perspective view illustrating a method of using the inventive post as a gate stop.

FIG. 12 is a perspective view illustrating a method of using the inventive post for installing the post to the corner of a house or square corner of a structure.

FIG. 13 is a top view illustrating a method of using the inventive post for securing a wood post.

FIG. 14 is a perspective view illustrating a method of using the inventive post for installing a kick board.

FIG. 15 is a perspective view of an alternative embodiment post having at least one beveled edge.

### DETAILED DESCRIPTION

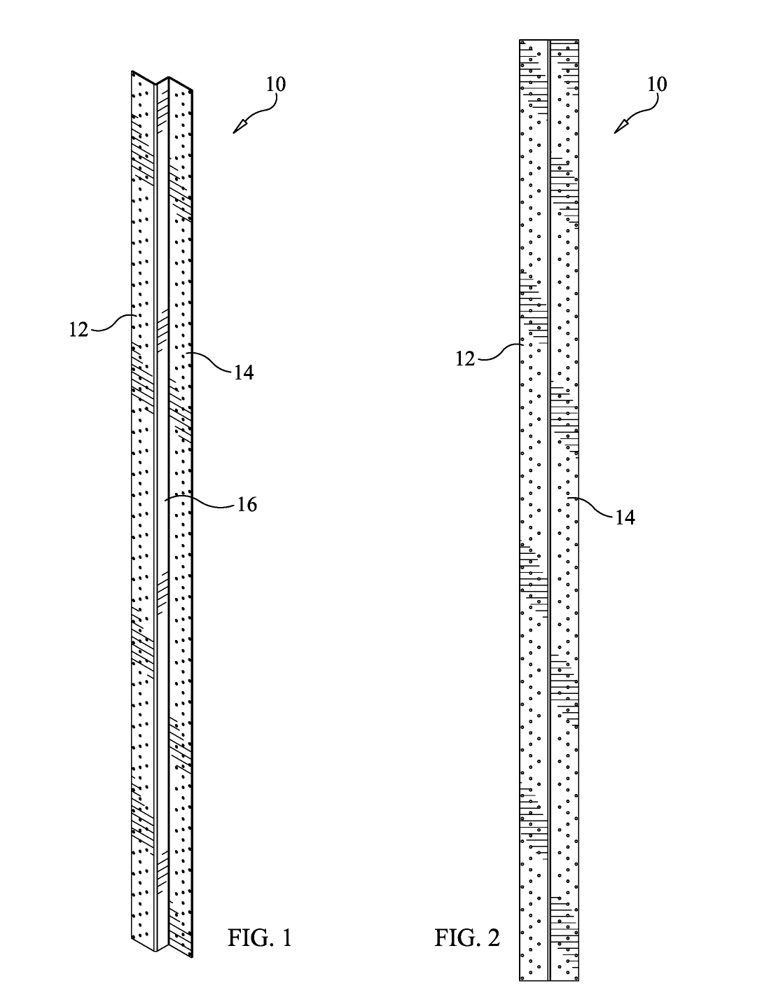

Referring now to the drawings, an embodiment of the inventive fence post is illustrated by FIG. 1. Fence post 10 is elongated and includes three panels or sections. The sections include an elongated, double-ended front flange section 12, an elongated, double-ended back flange section 14, and an elongated, double-ended connecting section 16 interconnecting the front flange section 12 and back flange section 14. The front 12 and back 14 flange sections are parallel to one another and the connecting section 16 is perpendicular to both flange sections. The overall cross-section of the fence post is generally a Z-shaped configuration.

In the arrangement illustrated, the sections are integrally connected, the post being of single piece construction, suitably formed by bending an elongated sheet of metal, such as ten-gauge, 55 KSI steel in one embodiment. As referenced above, the inventive post may be shaped, but may also be integrally formed to define elongated, double-ended front flange section 12, elongated, double-ended back flange section 14, and elongated, double-ended connecting section 16 interconnecting the front and back flange sections.

The post may, for example, be about six inches wide and eight feet long, formed of ten-gauge sheet metal steel bent and formed to accommodate standard two-by-four rails. The post may be metal powder coated in a selected color. In a preferred embodiment, the post is constructed of galvanized steel 10 gauge 55 KSI. The front and back flange sections offset of a standard two-by-four. The front and back sections may be two and one quarter inches (2¼″) across. The connecting section or panel 16 may be one and one half (1½″) across, allowing rails to be connected so that the fence frame is in alignment. The post may be set in the ground using any standard methods to set fence posts. The post can be set using a standard sized post hole—which may be 8-10″ around and 24″ deep, with a standard amount of fence mix concrete, which may be sixty to eighty pounds (60 lbs-80 lbs) per post, the post being set to level height similarly to a standard wood post.

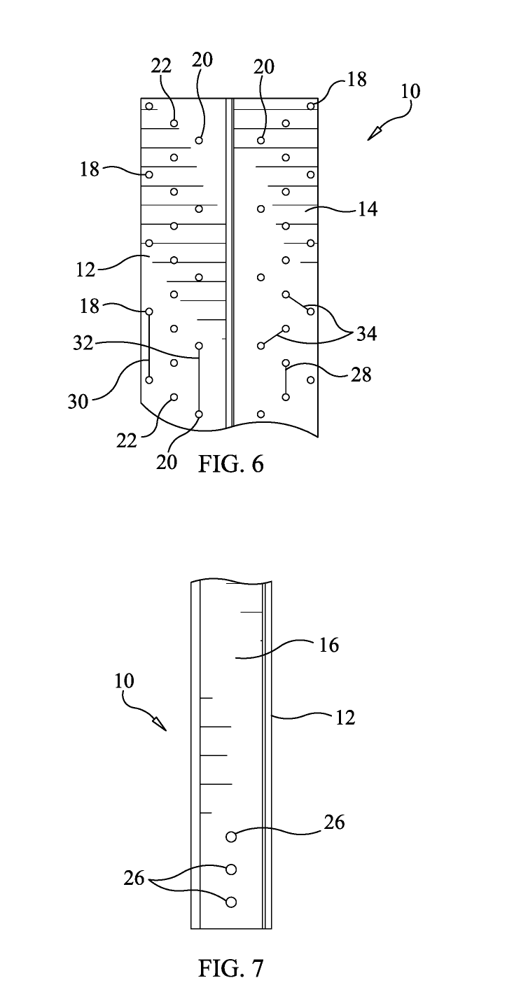

One aspect of the present invention, yielding unexpected results, is the inventive hole pattern formed in the front flange section 12, back flange section 14, and connecting section 16. The hole pattern in the front and back flange sections is a zig-zag pattern extending substantially all the way between the top and bottom ends of the front and back flange sections. In the example embodiment illustrated by FIG. 6, each zig-zag pattern includes an outer set of spaced, linearly aligned holes 18 extending along and closely adjacent to the outer free edges of the front 12 and back 14 flange sections. The zig-zag pattern also includes a set of spaced, linearly aligned inner holes 20 which extend along the lengths of front 12 and back 14 flange sections closely adjacent to connecting section 16. A third set of spaced linearly aligned holes, generally centrally disposed holes 22, extend along substantially the full lengths of the front and back flange sections between the locations of the inner and outer holes and generally centrally disposed relative thereto as well as generally centrally disposed in the front and back sections between the outer edges thereof and connecting section 16.

The number of holes employed will depend generally upon the length of the post. The numbers of holes employed may suitably be as follows:
7′ post 168 holes per flange 336 holes per post
7′ 6″ post 180 holes per flange 360 holes per post
8′ post 192 holes per flange 384 holes per post
10′ post 240 holes per flange 480 holes per post

In one embodiment, a nine-foot post may be used, this post having a number of holes in a similar proportion to the sample post lengths described above.

The hole pattern and hole placement provides, among others advantages, the following:
1. Allows installation of a kickboard or retaining wall;
2. Placement of one or more two-by-four(s) for gate installation;
3. Provides better grip or bite for rails or vertical two-by-fours;
4. When post is set in concrete, interlocks through holes are provided for better set;
5. Allows installation of two-by-fours for corners.

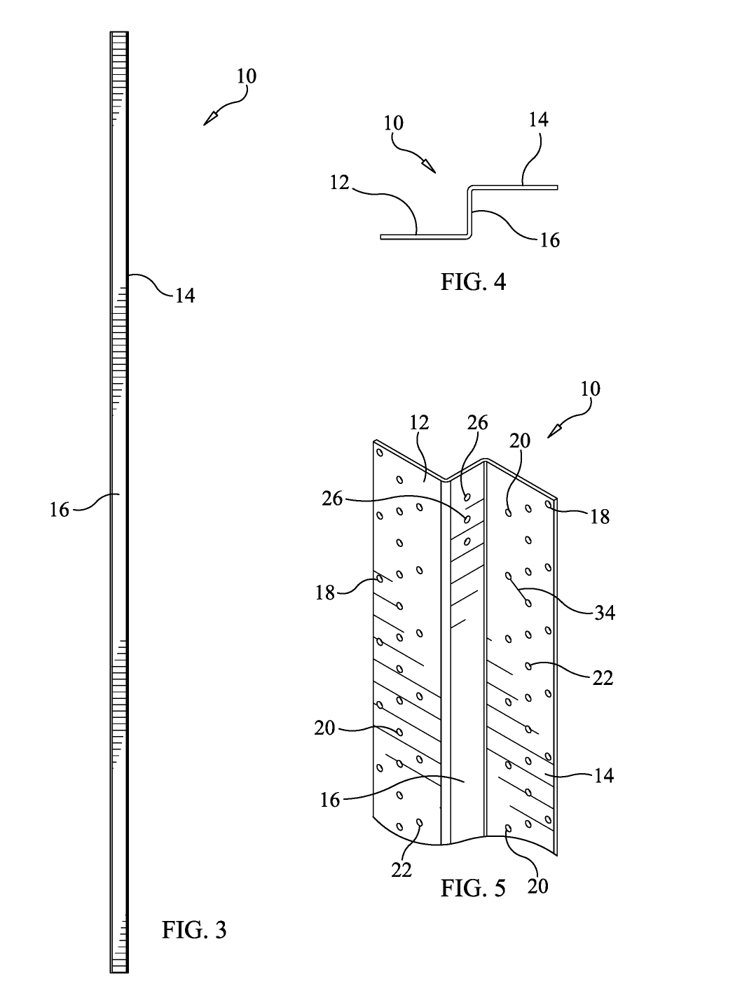

In one embodiment, a plurality of spaced one-quarter inch (¼″) connecting section holes 26 are located at the top and bottom portions of the connecting section 16 as illustrated by FIG. 3. The holes 26 are centrally located on the connecting section 16 relative to the front and back flange sections. Holes 76 are suitably spaced one inch (1″) apart and are employable for lattice attachment or other purposes. In an alternative embodiment, illustrated by FIG. 15, connecting section holes 1522 run continuously along the length of the section.

Turning now to FIG. 6, front flange section 12, and back flange section 14 have three sets of holes: an outer set 18, a centrally disposed set 22, and an inner set 20. A centrally disposed set of spaced, linearly aligned holes 22 have a centrally disposed hole-to-hole distance 28. In a preferred embodiment, the centrally disposed hole-to-hole distance is three-quarters of an inch (¾″). The outer set of spaced, linearly aligned holes 18 has an outer set hole-to-hole distance 30. In a preferred embodiment, the outer set hole-to-hole distance 30 is one and three quarter inches (1¾″). The inner set of spaced, linearly aligned holes 20 have a inner set hole-to-hole distance 32. In a preferred embodiment, the inner set hole-to-hole distance 32 is one and three quarter inches (1¾″). Lastly, moving from the post's top to bottom, or bottom to top, the hole pattern is in an overall zig-zag configuration—the next hole encountered being diagonally disposed from the last. Thus, there exists a diagonal hole-to-hole distance 34. In a preferred embodiment, the diagonal hole-to-hole distance is five-eighths of an inch (⅝″).

An example method to install the inventive fence post is as follows:

1. Fence posts should be set approximately 6′ to 8′ apart, and in one embodiment is seven (7′) feet, ten inches (10″) apart. The distance between posts will depend on the type of fence, terrain, purpose of fence, and height. It is recommended to set the posts in 8-10″ holes, approximately 24″ deep.

2. Installers should take time to measure and position the posts accurately. The appearance and the structural strength of the fence depend a great deal on the positioning of the fence posts. As a special note: standard rails are 8′ long, and installers should make posts set at or slightly below 8′ centers.

3. Set the corner or end posts first, then stretch a line from each corner or end post to align all the posts in between.

4. Drive a stake, then use chalk or paint every 6′ to 8′ to mark the exact position were the posthole is to be dug.

5. Set the post with 24″ buried in the ground. Note: Posts will be anchored more firmly by making the postholes slightly larger at the bottom than the top. Also, place a large stone or two shovels full of gravel in the bottom of each hole for drainage.

6. Use a level to ensure the posts are exactly straight and upright. Once the posts are level and in position, fill the hole around the post with concrete, sloping slightly away from the post and rounding it off with a trowel. Tamp the concrete lightly to eliminate any air bubbles.

7. Once the concrete is set (a process that can take 24 to 48 hours depending on weather conditions), the installer can begin to frame the fence. The hole patterns in the post simplify framing. Screw the rails into the flanges of the post with 1½″ galvanized or coated screws—the rails will sit flush with the flange design of the post, ensuring a straight fence line. Note: The top of the posts can either be set to height or can easily be cut off with a saws all or band saw.

8. The final step will be to install the fence boards, beginning by installing the boards at each end of the fence. Then string a line tightly at the top of each of these boards. Nail or screw the fence boards using the string as a reference. Note: For a standard fence, the boards should extend approximately 8″ above the top rail, and the bottom rail should be approximately 10″ above the ground.

A kickboard can be installed on the lower portion of the post. The installer mounts the kickboard on the front flange section. This kickboard can have the added utility of retaining dirt in a desired location. To install a good neighbor fence variant—with a kickboard alternating between one side of the fence, then the other, a kickboard is alternatively installed on the front flange section 12 and then on the rear flange section for the next length.

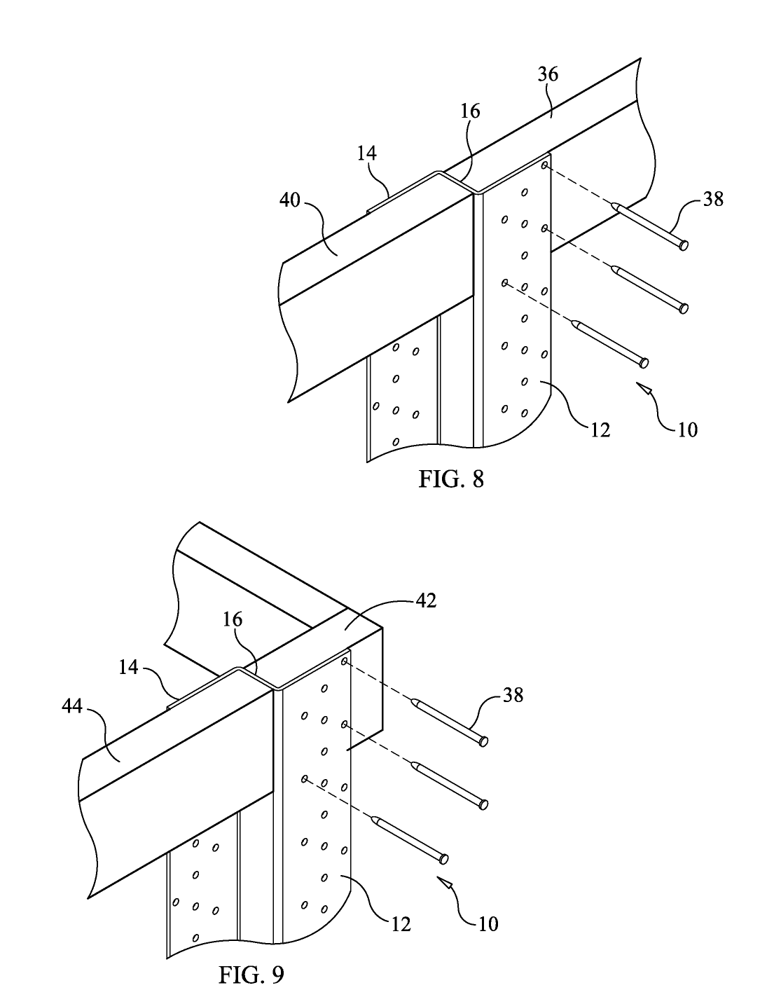

FIG. 8 illustrates use of the inventive post as a line post. First, an installer determines where to attach rails. Front flange section 12 of post 10 is affixed to a rail 36 using fasteners 38—which may be #8×one and five eighths inch (1⅝″) rail screws as an example. Back flange section 14, is attached to a second rail 40. Double-ended connecting section 16 makes contact with rail 36 and second rail 40.

FIG. 9 illustrates use of the inventive post as a corner post. For example, a two-by-four (2×4) 42 may be attached to post 10 such that front flange section 12 is secured to two-by-four 42 by fasteners 38. In one example, the fasteners 38 may be #8 one and five eighths inch (1⅝″) rail screws. Rail 44 may be attached to back flange section 14. Double-ended connection section 16 makes contact with rail 44 and two-by-four 42.

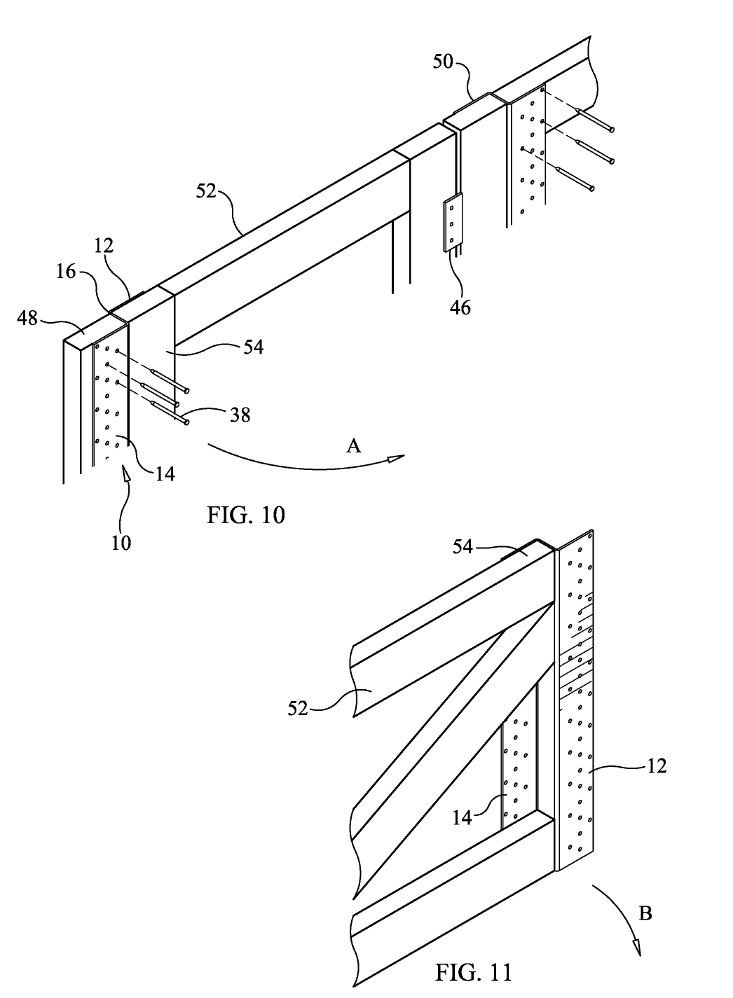

FIGS. 10 and 11 illustrate use of the inventive post as a gate post. First, the installer determines the desired direction of gate swing. FIG. 10 illustrates gate 52 that opens inwardly along path A. The inventive post 10 can serve as a latch post. Back flange section 14 is secured to latch post fence section 48 by fasteners 38. Gate 52 is hingably attached to hinge post fence section 50 by hinge 46. (For illustrative purposes, only top hinge 46 is shown however at least one additional hinge is required). Front flange section 12 serves as a gate stop for the terminal gate end 54 of gate 52. FIG. 11 illustrates another view of a gate swinging inwardly along path B. Front flange 12 is secured to a latch post fence section 48 (holes and fasteners are omitted for illustrative purposes). Back flange section 14 serves as a gate stop for the terminal gate end 54 of gate 52.

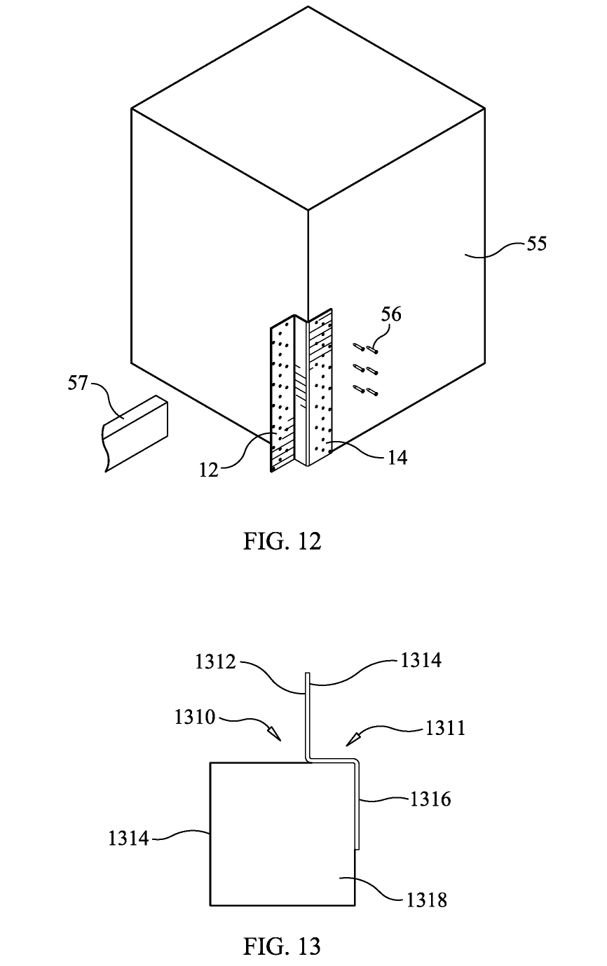

FIG. 12 illustrates the present invention further and also describes an inventive method for installing the inventive post to the corner of a house or square corner of a structure. The inventive post as described and fasteners are provided with fasteners selected from the group comprising: lag bolts or wood screws, as examples. The installer fastens the back end 14 of post to the corner of a desired structure 55, wherein the fasteners 56, which in one embodiment may be one quarter inch (¼″) lag screws are passed through holes in the elongated, double-ended back flange section 14 of said post and driven into structure 55. The front flange section 12 is attached to provided fencing structure (illustrated by two-by-four 57); fastening said post to fencing structure. Fasteners (not shown) are passed through holes in the elongated, double-ended front flange section 12 of said post and driven into the fencing structure 57. This method has been found particularly helpful in instances where the installer cannot dig in close proximity to the structure due to the foundation or pipe layout. Advantageously, the inventive post installed in the described manner can act as a termite flashing. The inventive post may be on a variety of structures such as but not limited to wood, metal, stucco, and concrete.

FIG. 13 illustrates an inventive method of providing a support structure for a target wood post 1318, which may need reinforcing, using two inventive fence posts. A first post 1310 and second post 1311 are provided. First post front flange section 1312 is attached to second post front flange section 1314. First post back flange section 1314 and second post rear flange section 1316 are connected to the target post 1318.

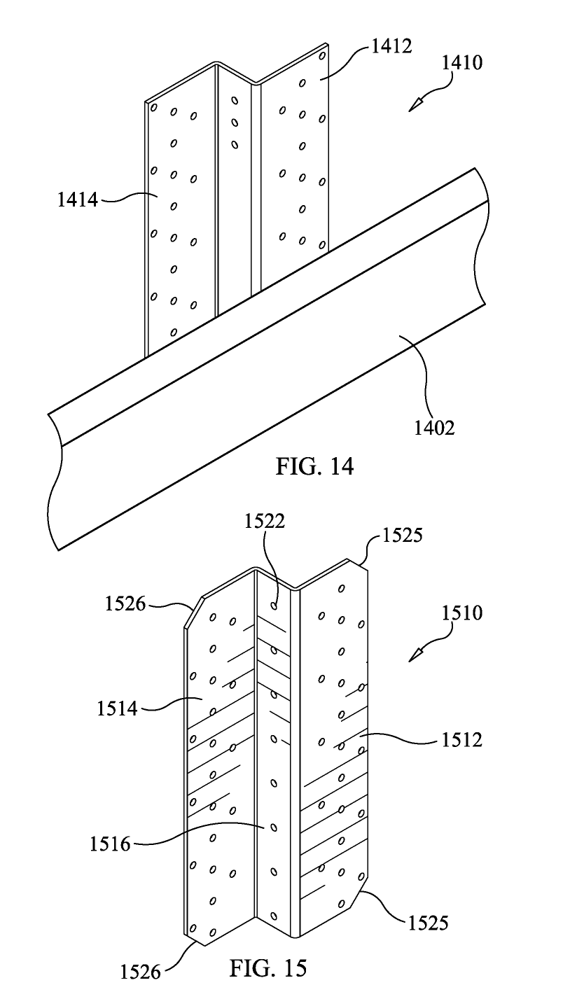

FIG. 14 illustrates an inventive method for providing a kick board which may serve as a retaining wall for dirt. The inventive post and kickboard, such as a two-by-twelve (2×12′) board are provided. The installer digs at least two holes in the ground; setting at least two posts with 24″ buried in the dug holes. The installer ensures the posts are exactly straight and upright. Next, fill the holes around the post with concrete, sloping slightly away from the post and rounding the concrete off with a trowel and tamping the concrete lightly to eliminate any air bubbles. Allow the concrete to set. Mount kickboard 1402 on the front flange section 1412 of the post 1410.

In an alternative embodiment, the inventive post may be shaped to allow more easy penetration into the ground. Another alternative provides for continuous holes along the connection section of the post. These alternatives are independent of each other and could be used together or distinctly.

FIG. 15 illustrates post 1510 wherein one or more outermost corners of the front flange section 1512 and the back flange section 1514 are shaped to define a beveled outermost corner 1525 and 1526 respectively. Beveled corners 1525 and 1526 may be at any angle—however a useful angle would be 45 degrees. Beveled corners allow a post to be more easily driven into the ground and aid in fence post placement and fence installation in general.

The inventive post may be used to install a lattice above a fence by affixing the lattice to the front or back flange.

It should be noted and clear to one skilled in the art that designation of the front flange section 12 and back flange section 14 are arbitrary and are used for illustrative purposes only as they are symmetrical.

Although the present invention has been described with reference to the preferred embodiments, it should be understood that various modifications and variations can be easily made by those skilled in the art without departing from the scope and spirit of the invention. Accordingly, the foregoing disclosure should be interpreted as illustrative only and is not to be interpreted in a limiting sense. It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

We claim:

1. A fence post comprising: an elongated, double-ended front flange section; an elongated, double-ended connecting section interconnecting the front flange sections; an elongated, double-ended back flange section connected to said elongated, double-ended connecting section interconnecting the front flange sections, wherein said elongated, double-ended front flange section and said elongated, double-ended back flange section are parallel to one another, wherein said elongated, double-ended connecting section interconnecting the front flange sections is perpendicular to said elongated, double-ended front flange section and said elongated, double-ended back flange section, wherein the overall cross-section of the fence post is generally a Z-shaped configuration, wherein said post is comprised of ten-gauge, 55 KSI steel, wherein said elongated, double-ended front flange section is two and one quarter inches (2¼″), wherein said elongated, double-ended connecting section is one and one half (1½″) across, wherein said elongated, double-ended back flange section is two and one quarter inches (2¼″), wherein said post has a plurality of holes, wherein elongated, double-ended front flange section and elongated, double-ended back flange section each have three sets of holes, wherein a first set is an outer set of spaced, linearly aligned holes, wherein the outer set has an outer set hole-to-hole distance, wherein the outer set hole-to-hole distance is one and three quarter inches (1¾″), wherein a second set is a centrally disposed set of spaced linearly aligned holes, wherein the centrally disposed set has a centrally disposed set hole-to-hole distance, wherein the centrally disposed set hole-to-hole distance is three-quarters of an inch (¾″), wherein a third set is an inner set of spaced, linearly aligned holes, wherein the inner set has an inner set hole-to-hole distance, wherein the inner set hole-to-hole distance is one and three quarter inches (1¾″), wherein said post has a top and a bottom, wherein moving from the post's top to bottom, or bottom to top, the hole pattern is in a zig-zag configuration, whereby the next hole encountered is diagonally disposed from the last, wherein a diagonal hole-to-hole distance exists, wherein said diagonal hole-to-hole distance is five-eighths of an inch (⅝″), wherein each hole has a diameter of one-quarter inch (¼″).

2. The post of claim 1, wherein the elongated, double-ended front flange section is shaped to define a beveled outermost corner angle, wherein the elongated, double-ended back flange section is shaped to define a beveled outermost corner angle.

3. The post of claim 1, wherein the elongated, double-ended connecting section is shaped to define connecting section holes located at the top and bottom portions of the connecting section.

4. The post of claim 1, wherein the elongated, double-ended connecting section is shaped to define connecting section holes located continuously along the connection section of the post.

5. A method of installing a post to the corner of a house or square corner of a structure, said method comprising: providing an elongated, double-ended front flange section; an elongated, double-ended connecting section interconnecting the front flange sections; an elongated, double-ended back flange section connected to said elongated, double-ended connecting section interconnecting the front flange sections, wherein said elongated, double-ended front flange section and said elongated, double-ended back flange section are parallel to one another, wherein said elongated, double-ended connecting section interconnecting the front flange sections is perpendicular to said elongated, double-ended front flange section and said elongated, double-ended back flange section, wherein the overall cross-section of the fence post is generally a Z-shaped configuration, wherein said post is comprised of ten-gauge, 55 KSI steel, wherein said elongated, double-ended front flange section is two and one quarter inches (2¼″), wherein said elongated, double-ended connecting section is one and one half (1½″) across, wherein said elongated, double-ended back flange section is two and one quarter inches (2¼″), wherein said post has a plurality of holes, wherein elongated, double-ended front flange section and elongated, double-ended back flange section each have three sets of holes, wherein a first set is an outer set of spaced, linearly aligned holes, wherein the outer set has an outer set hole-to-hole distance, wherein the outer set hole-to-hole distance is one and three quarter inches (1¾″), wherein a second set is a centrally disposed set of spaced linearly aligned holes, wherein the centrally disposed set has a centrally disposed set hole-to-hole distance, wherein the centrally disposed set hole-to-hole distance is three-quarters of an inch (¾″), wherein a third set is an inner set of spaced, linearly aligned holes, wherein the inner set has an inner set hole-to-hole distance, wherein the inner set hole-to-hole distance is one and three quarter inches (1¾″), wherein said post has a top and a bottom, wherein moving from the post's top to bottom, or bottom to top, the hole pattern is in a zig-zag configuration, whereby the next hole encountered is diagonally disposed from the last, wherein a diagonal hole-to-hole distance exists, wherein said diagonal hole-to-hole distance is five-eighths of an inch (⅝″), wherein each hole has a diameter of one-quarter inch (¼″);
providing fasteners, said fasteners selected from the group comprising: lag bolts or wood screws; fastening said post to the corner of the structure, wherein said fasteners are passed through holes in the elongated, double-ended front flange section of said post and driven into said structure; providing fencing structure; fastening said post to fencing structure, where said fasteners are passed through holes in the elongated, double-ended back flange section of said post and driven into the fencing structure.

6. A method of providing a support structure for a target wood post using two fence posts, the method comprising: providing two fence posts, wherein a fence post comprises: an elongated, double-ended front flange section; an elongated, double-ended connecting section interconnecting the front flange sections; an elongated, double-ended back flange section connected to said elongated, double-ended connecting section interconnecting the front flange sections, wherein said elongated, double-ended front flange section and said elongated, double-ended back flange section are parallel to one another, wherein said elongated, double-ended connecting section interconnecting the front flange sections is perpendicular to said elongated, double-ended front flange section and said elongated, double-ended back flange section, wherein the overall cross-section of the fence post is generally a Z-shaped configuration, wherein said post is comprised of ten-gauge, 55 KSI steel, wherein said elongated, double-ended front flange section is two and one quarter inches (2¼″), wherein said elongated, double-ended connecting section is one and one half (1½″) across, wherein said elongated, double-ended back flange section is two and one quarter inches (2¼″), wherein said post has a plurality of holes, wherein elongated, double-ended front flange section and elongated, double-ended back flange section each have three sets of holes, wherein a first set is an outer set of spaced, linearly aligned holes, wherein the outer set has an outer set hole-to-hole distance, wherein the outer set hole-to-hole distance is one and three quarter inches (1¾″), wherein a second set is a centrally disposed set of spaced linearly aligned holes, wherein the centrally disposed set has a centrally disposed set hole-to-hole distance, wherein the centrally disposed set hole-to-hole distance is three-quarters of an inch (¾″), wherein a third set is an inner set of spaced, linearly aligned holes, wherein the inner set has an inner set hole-to-hole distance, wherein the inner set hole-to-hole distance is one and three quarter inches (1¾″), wherein said post has a top and a bottom, wherein moving from the post's top to bottom, or bottom to top, the hole pattern is in a zig-zag configuration, whereby the next hole encountered is diagonally disposed from the last, wherein a diagonal hole-to-hole distance exists, wherein said diagonal hole-to-hole distance is five-eighths of an inch (⅝″), wherein each hole has a diameter of one-quarter inch (¼″);
providing fasteners, said fasteners selected from the group comprising: lag bolts or wood screws; securing the front flange sections together with the fasteners; securing the rear flange sections to the target wood post.

7. The method of claim 6, wherein the target wood post is a four-by-four.

8. The method of claim 6, wherein the target wood post is a four-by-six.

9. A method of installing a gate, providing a metal gate stop, the method comprising: providing an elongated, double-ended front flange section; an elongated, double-ended connecting section interconnecting the front flange sections; an elongated, double-ended back flange section connected to said elongated, double-ended connecting section interconnecting the front flange sections, wherein said elongated, double-ended front flange section and said elongated, double-ended back flange section are parallel to one another, wherein said elongated, double-ended connecting section interconnecting the front flange sections is perpendicular to said elongated, double-ended front flange section and said elongated, double-ended back flange section, wherein the overall cross-section of the fence post is generally a Z-shaped configuration, wherein said post is comprised of ten-gauge, 55 KSI steel, wherein said elongated, double-ended front flange section is two and one quarter inches (2¼″), wherein said elongated, double-ended connecting section is one and one half (1½″) across, wherein said elongated, double-ended back flange section is two and one quarter inches (2¼″), wherein said post has a plurality of holes, wherein elongated, double-ended front flange section and elongated, double-ended back flange section each have three sets of holes, wherein a first set is an outer set of spaced, linearly aligned holes, wherein the outer set has an outer set hole-to-hole distance, wherein the outer set hole-to-hole distance is one and three quarter inches (1¾″), wherein a second set is a centrally disposed set of spaced linearly aligned holes, wherein the centrally disposed set has a centrally disposed set hole-to-hole distance, wherein the centrally disposed set hole-to-hole distance is three-quarters of an inch (¾″), wherein a third set is an inner set of spaced, linearly aligned holes, wherein the inner set has an inner set hole-to-hole distance, wherein the inner set hole-to-hole distance is one and three quarter inches (1¾″), wherein said post has a top and a bottom, wherein moving from the post's top to bottom, or bottom to top, the hole pattern is in a zig-zag configuration, whereby the next hole encountered is diagonally disposed from the last, wherein a diagonal hole-to-hole distance exists, wherein said diagonal hole-to-hole distance is five-eighths of an inch (⅝″), wherein each hole has a diameter of one-quarter inch (¼″); installing a length of fencing; determining the need for a gate; providing a gate hingably affixed to a length of fencing; installing a gate stop length of fencing; affixing the front flange section to the gate stop length of fencing such that the connecting section is in contact with the gate stop length of fencing; wherein the back flange section makes contact with the gate serving as a gate stop.

10. A method of providing a kick stop, the method comprising: providing an elongated, double-ended front flange section; an elongated, double-ended connecting section interconnecting the front flange sections; an elongated, double-ended back flange section connected to said elongated, double-ended connecting section interconnecting the front flange sections, wherein said elongated, double-ended front flange section and said elongated, double-ended back flange section are parallel to one another, wherein said elongated, double-ended connecting section interconnecting the front flange sections is perpendicular to said elongated, double-ended front flange section and said elongated, double-ended back flange section, wherein the overall cross-section of the fence post is generally a Z-shaped configuration, wherein said post is comprised of ten-gauge, 55 KSI steel, wherein said elongated, double-ended front flange section is two and one quarter inches (2¼″), wherein said elongated, double-ended connecting section is one and one half (1½″) across, wherein said elongated, double-ended back flange section is two and one quarter inches (2¼″), wherein said post has a plurality of holes, wherein elongated, double-ended front flange section and elongated, double-ended back flange section each have three sets of holes, wherein a first set is an outer set of spaced, linearly aligned holes, wherein the outer set has an outer set hole-to-hole distance, wherein the outer set hole-to-hole distance is one and three quarter inches (1¾″), wherein a second set is a centrally disposed set of spaced linearly aligned holes, wherein the centrally disposed set has a centrally disposed set hole-to-hole distance, wherein the centrally disposed set hole-to-hole distance is three-quarters of an inch (¾″), wherein a third set is an inner set of spaced, linearly aligned holes, wherein the inner set has an inner set hole-to-hole distance, wherein the inner set hole-to-hole distance is one and three quarter inches (1¾″), wherein said post has a top and a bottom, wherein moving from the post's top to bottom, or bottom to top, the hole pattern is in a zig-zag configuration, whereby the next hole encountered is diagonally disposed from the last, wherein a diagonal hole-to-hole distance exists, wherein said diagonal hole-to-hole distance is five-eighths of an inch (⅝″), wherein each hole has a diameter of one-quarter inch (¼″); providing a kickboard; digging at least two holes in the ground; setting at least two posts with 24″ buried in the dug holes; ensuring the posts are exactly straight and upright; filling the holes around the post with concrete, sloping slightly away from the post and rounding the concrete off with a trowel and tamping the concrete lightly to eliminate any air bubbles; allowing the concrete to set; mounting a kickboard on the front flange section of the post.

11. The method of claim 10, further comprising, providing at least a second kickboard, mounting the second kickboard on the back flange section of the post to provide a good-neighbor style fence.
